(19) United States
(12) Patent Application Publication
(10) Pub. No.: US 2011/0231354 A1
(43) Pub. Date: Sep. 22, 2011

(54) TRANSPORT MANAGEMENT SYSTEM

(76) Inventors: Sean O'Sullivan, Cork (IE); Harvey Appelbe, Kildare (IE); Greg Balmer, Wicklow (IE)

(21) Appl. No.: 12/733,083

(22) PCT Filed: Jul. 24, 2008
(86) PCT No.: PCT/IE2008/000076

§ 371 Date: Feb. 5, 2010

Related U.S. Application Data
(62) Division of application No. 60/935,370, filed on Aug. 9, 2007.
Application No. 60/935,370 is a division of application No. 60/960,944, filed on Oct. 22, 2007.

(51) Int. Cl. G06N 5/02

(52) U.S. Cl. 706/46

(57) ABSTRACT

A car pooling transport management system (1) comprises a central server (2) having a bank of prediction servers (3) linked with a geographical model (4). Vehicle on-board units (OBUs, 6) have prediction clients (7) which communicate with the central server (2) via a mobile network (10). Each OBU (6) has a satellite locating system, in this case GPS-based, to track actual vehicle position. Each prediction client 7 develops a vehicle prediction model for the driver's regular routes and communicates data concerning the vehicle prediction model to a prediction server (3) running on the central server (2), and in a normal transport/commuting mode compares in real time the position and timing of the actual mute of the vehicle against a route of the vehicle prediction model and transmits progress updates to the prediction server (3). The prediction server 3 consolidates the data from the various prediction clients 7 and builds a geographical model 4 for all of the OBUs 6 of the system 1. Using the geographical model (4), the prediction server (3) can continue to provide predictions of the vehicle's progress, such that passenger requests can be processed without using the costly communication resource. Only when the prediction client (7) decides that vehicle progress has materially deviated from its predicted route, by comparing actual progress from say GPS with the local client prediction, does it communicate with the server 3.

### FIELD OF THE INVENTION

The invention relates to a transport system for managing utilisation of shared vehicles.

### PRIOR ART DISCUSSION

U.S. Pat. No. 6,697,730 (Georgia Tech) describes an urban transit system employing cellular communication, GPS locating technology, and computers to provide real time command and control of passengers and vehicles.

JP2004220396 describes a car sharing information supply system.

US2003182183 describes a method of organising a multi car pool.

U.S. Pat. No. 7,136,747 describes a method of GPS rendezvous tracking and personal safety verification

A problem with existing car sharing urban transport systems is that of providing up-to-date location and route information. Typically, this involves costly frequent mobile network transmissions.

It should be noted that in such systems a server must know the intended route of each vehicle in order to know which subset of vehicles should be offered a job. It is not sufficient to merely ask the driver at the start of their journey which route they intend to take, since driving conditions are dynamic. Their destination might change, they may deviate from the route momentarily, or their progress along the route may change unexpectedly, due to traffic conditions and the driver's free will.

If the devices do not submit regular update information, the server's understanding of vehicles on the ground will fall out of date. Without updates, when a demand is placed by a traveller, the server would need to pool each and every vehicle to determine if its situation is as expected. This would take too much time to provide a practical service to the traveller.

Utilising costly cellular communication resources (such as GPRS) for regular updates increases the overall cost of operating these services to a point where it compares unfavourably with the actual cost of the transport service itself. Adoption of such location-based services has therefore until now been limited.

Additionally, it is not practical to assume that cellular communication coverage is available all of the time, and hence a method is needed to allow services to be provided when cellular communication coverage is available only intermittently.

The invention addresses this problem.

### SUMMARY OF THE INVENTION

According to the invention, there is provided a transport management system comprising:
a plurality of on-board units each for installation in a vehicle free to travel on different routes, and comprising a wireless transceiver;
a server;
wherein each on-board unit comprises a prediction client adapted to:
   monitor vehicle actual position,
   use monitored vehicle actual positions to generate a vehicle prediction model of routes frequently travelled by its associated vehicle,
   transmit data concerning the vehicle prediction model to the server, and
   transmit vehicle progress data updates to the server as the associated vehicle travels on a route
wherein the server is adapted to:
   receive said data concerning the vehicle prediction model from each prediction client and use it to generate and maintain a geographical prediction model, and
   use the geographical prediction model to generate predictions of each vehicle position, so that only infrequent vehicle progress updates are required from the prediction clients.

In one embodiment, the on-board unit comprises a satellite tracking device, and the prediction client receives vehicle actual location data from said satellite tracking device.

In another embodiment, the server is adapted to update the geographical model according to vehicle progress updates received from the clients, so that the geographical model is synchronised with the vehicle prediction models.

In a further embodiment, each prediction client is adapted to compare actual vehicle location with a predicted location, and to transmit vehicle progress updates to the server only if actual vehicle location differs from predicted location by more than a tolerance level.

In one embodiment, the tolerance level is variable. The tolerance level may vary according to time and date, and each prediction client may determine deviation according to a clustering algorithm.

In one embodiment, the data transmitted by the client concerning the vehicle prediction model is an initial model.

In one embodiment, the server is adapted to apply additional information when generating predictions of a vehicle's position.

In another embodiment, said additional information is derived from a common model of common traffic information including unusual delays on roads.

In one embodiment, the prediction client is adapted to transmit an initial progress update indicating a route being commenced by an associated vehicle.

In one embodiment, the prediction client is adapted to employ a stochastic method to automatically determine a route being commenced without need for a user input.

In a further embodiment, each prediction client generates a server update when an associated vehicle passes predetermined stop locations along a predicted route.

In one embodiment, the prediction client is adapted to build the vehicle prediction model on a framework of route stop data.

In one embodiment, the server is adapted to perform automatic discovery of stops by recording stop data from progress updates from a first prediction client vehicle and applying said stop data to the a route for a second prediction client.

In one embodiment, the server is adapted to apply regions around route stops and to identify a potential additional stop for the second vehicle if its route passes through said region.

In another embodiment, each stop is given an attribute of being unidirectional or bi-directional.

In one embodiment, the server is adapted to query the second prediction client before applying additional route data.

In one embodiment, the vehicle prediction model comprises statistics for each of a plurality of time slots for each line between two stops.

In one embodiment, for each time slot the following statistics are maintained on a running basis:
average time duration taken to move between the stops,
variability of the duration,
rolling link usage frequency indicating the probability that the link will be driven, and
relative link performance rating live feedback of the prediction performance for the link.

In another aspect, the invention provides a computer readable medium comprising software code for performing operations of any system defined above when executing on a digital processor.

### DETAILED DESCRIPTION OF THE INVENTION

### BRIEF DESCRIPTION OF THE DRAWINGS

The invention will be more clearly understood from the following description of some embodiments thereof, given by way of example only with reference to the accompanying drawings in which:—

FIG. 1 is a diagram illustrating a transport management system for management of car pooling;

FIG. 2 is a diagrammatic representation of a prediction model;

FIG. 3 shows geographic layout of a modelled route;

FIG. 4 shows data structure for part of a model;

FIG. 5 is a representation of a model for a city; and

FIG. 6 shows processing for locating stops on a route model.

### DESCRIPTION OF THE EMBODIMENTS

### System Overview

Referring to FIG. 1 a car pooling transport management system 1 comprises a central server 2 having a bank of prediction servers 3 linked with a geographical model 4. Vehicle on-board units (“OBUs”) 6 have prediction clients 7 which communicate with the central server 2 via a mobile network 10. Each OBU 6 has a satellite locating system, in this case GPS-based, to track actual vehicle position. The hardware for the OBU is available as is known by those skilled in the art, the invention residing in the manner in which the OBUs 6 and the servers 3 are programmed.

Each prediction client 7 serves two purposes:
(a) in a data gathering and modelling mode, to locally, on the vehicle, develop a vehicle prediction model for the driver's regular routes, and to communicate data concerning the vehicle prediction model to a prediction server 3 running on the central server 2, and
(b) in a normal transport/commuting mode, to compare in real time the position and timing of the actual route of the vehicle against a route of the vehicle prediction model and transmit progress updates to the prediction server 3.

The prediction server 3 consolidates the data from the various prediction clients 7 and builds a geographical model 4 for all of the OBUs 6 of the system 1.

When in the normal prediction mode, for as long as the driver continues on the route as predicted, there is no need for further communication. Using the geographical model 4, the prediction server 3 can continue to provide predictions of the vehicle's progress, such that passenger requests can be processed without using the costly communication resource.

Only when the prediction client 7 decides that vehicle progress has ‘materially’ deviated from its predicted route, by comparing actual progress from say GPS with the local client prediction, does it communicate with the server 3. This allows the server 3 to update its vehicle position and make predictions for subsequent passenger queries from this basis. Also, the server 3 can use such updates to improve the prediction geographical model, so that it can make improved predictions in the future.

The thresholds used by each vehicle's prediction client 7 to determine ‘material’ deviation may change as the vehicle's role changes. For instance, if a booking is about to be placed with the vehicle, the server 3 might insist on greater specificity. Or, for geographic areas where the demand for the service is limited or not required to be as accurate, for example in the middle of the night when no-one is waiting for a pick-up, the server 3 could loosen the update parameters so that almost any deviation is not ‘material’. The vast majority of vehicles can operate with infrequent communication updates while the server has an approximate knowledge of actual progress, ensuring low communication usage.

Data communication can be reduced even further by use of a common model at the prediction server 3, for example if an accident on a major route causes a number of vehicles in the system to report an unusual condition. Using a common prediction server model, the prediction servers 3 can understand the implications for vehicles that have not yet met the accident. An added benefit of this common model approach is that those vehicle drivers who will likely be affected by an accident could be notified by a message initiated by the prediction server 3.

Since the communication between the prediction client 7 and the prediction server 3 only occurs at the start of the journey and when there are exceptions, the use of costly cellular bandwidth on the network 10 is significantly reduced. In the majority of cases, where dynamic ride sharing system is applicable, drivers follow well established habits, dominated by the handful of optimal commute routes. With acceptable bounds, variations in the vehicle's progress are predictable.

By positioning each prediction client 7 in a vehicle with the GPS device it can work with significantly more location intelligence (at 1 sec intervals) than if it relied only on data sent over GPRS at say 15 sec intervals. The prediction server 3 can provide calling applications with location intelligence at, for example, a 1 sec interval. This enables decisions, such as allocating passengers to vehicle, to be made with much greater resolution. The calling application is not aware that the data provided by the server 3 is actually a prediction.

By the prediction clients 7 maintaining models that accurately predict the drivers' journey progress, rather than a generic traffic route model, a matching engine in the central server 2 is able to allocate riders to drivers more precisely.

The use of synchronised prediction client 7 and server 3 makes it possible to know when road conditions are changing due to unusual congestion, by offloading the modelling workload to a distributed network of parallel processors, namely the on-board units 6 with prediction client software. Each OBU 6 performs its own data gathering and analysis with access to the local GPS. The system provides a greater processing capacity at lower cost than if a large central server were to interpret the incoming data points from potentially thousands or tens of thousands of simultaneously active distributed devices.

### Method of Operation

The prediction client 7 has access to the driver's regular routes by virtue of the locally-stored model. The driver normally selects from a list of preferred routes, ordered by location and time.

The client 7 also gets a constant feed of location information from GPS. Being on-board, therefore local to the GPS receiver, the feed operates at 1 Hz, providing excellent resolution. Early in the route the client 7 notifies the prediction server 3 of the vehicle's intended route, and the departure time. The intended route can be expressed in terms of stops or roads visited and the expected time after embarking that each will be visited. Working on the known route and departure time, the server 3 can now issue regular predictions of the vehicle's progress based on the model 4, which of course is synchronised with the vehicle prediction model.

Similar prediction is taking place on the client, such that the output progress from the client and the server are similar and synchronised. The output progress in this case might take the form of simple coordinate locations and times.

The client 7 monitors the quality of its own output, by comparing it with the actual progress being made. This can be as simple as comparing the predicted coordinates and time, with the actual GPS coordinates and time. The quality metric being the time delayed, for example, “running 5 mins behind schedule”. According to the nature of the route, this might equate to 100 m or 500 m. The important metric in this application is the delay.

When the quality of the client's prediction deteriorates below a threshold (e.g. 5 min behind prediction), the client 7 knows that the server's prediction is also unacceptable. Therefore the client 7 transmits to the server 3 information to adjust the server's prediction. In the simplest case, the client 7 calculates the values required to bring its own prediction into line with the actual.

Using cluster analysis methods (such as Tree Clustering, Two-way Joining, k-Means) the client is able to detect when the vehicle has substantially deviated from the planned route. The client 7 may attempt to deduce that actual route, or prompt the user for more information. In any case, the server is notified by the client, so that the information provided to the central model is modified accordingly.

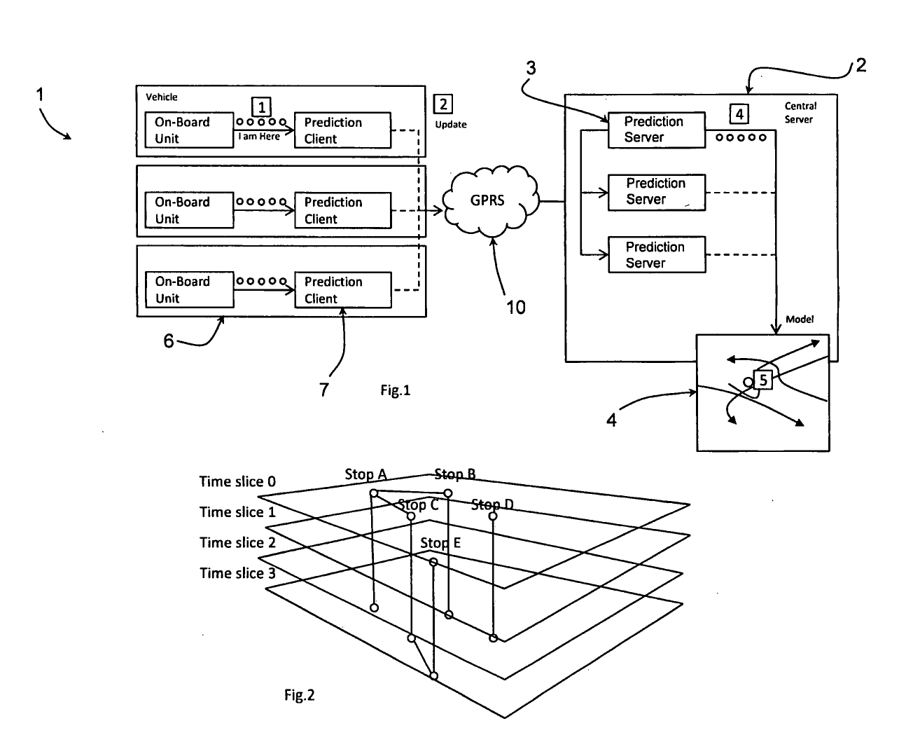

The prediction client 7 does not necessarily require the user to specify their route at the start of their journey. The prediction client 7 can operate much less deterministically. Using stochastic methods, the prediction client 7 can, over time, build up a state space model, a simple 5-stop case being illustrated in FIG. 2.

For each point (or stop, or road junction), this model predicts which subsequent path the vehicle will take. The prediction client 7 has created the model by monitoring the driver's actual behaviour over many journeys. In this way, the prediction client 7 can say that if the driver visits Stop 2 from Stop 1 at a certain time of day, they will likely now go to Stop 3, rather than Stop 4.

In this embodiment, the driver's intention to drive a certain route can be deduced because of habit. Consider that a commuter may only have four alternative routes to work. Of course, when this system is applied to scheduled transport (such as bus routes) the deduction is even stronger. For example, if a driver takes a right turn out of his driveway, rather than a left, it may eliminate ¼ or perhaps even ¾ of the possible destinations. If he then proceeds straight for three minor streets and at the major intersection takes a left, it could be deduced with perhaps 95% probability that he is on a route going to work. If it is a Monday morning, and this is his normal schedule, it can be predicted with even greater certainty. In this way, a combination of time schedules and location sensing determinations would rapidly provide the prediction client 7 with a likely destination, saving the driver the effort necessary to select it, and therefore, increasing the possibility that the system would be used more consistently.

### Route Definition

The route models are based on ‘stops’. These are geographically placed points that allow one to understand where a driver drives, and where passengers wish to be picked up and dropped off. Stops are recorded and then provide a framework for generation of the vehicle prediction model.

Only two stops are required at a minimum for the route of any particular driver to be recorded. Normally there would be a number of stops on a driver's route. Stops might be static—say by taking the known position of bus stops. The stops are stored in the geographical model 4 waiting for routes to be registered, that join the stops and form the model. The stops can be directional, bidirectional or omnidirectional, according to whether they serve both side of the road, or all directions. These attributes are used to make the stops more intelligent than simple points. For instance, by having direction the server can tell if a stop is on a fly-over or on the road below.

### Route Registration

To create a vehicle prediction model, a driver turns on the OBU 6 and may opt to indicate a route, or the client 7 predicts it. The client 7 collects the location data provided by the GPS. Once the vehicle has moved a reasonable distance, from time to time the client 7 interacts with the server 2 to request all stops within the bounding box that covers all of the GPS for this period.

The intermittent nature of this interaction is a key strength, it is an asynchronous process that ensures it is not one long process that could fail if there is poor cellular communication 10 coverage. Also, it means that work is happening during the journey, rather than in one large job when the vehicle has parked up. By doing it in batches the job is almost entirely done when the vehicle has finished driving.

This is not to say it couldn't be done in one batch. When the route has been driven the client 7 matches the stops with the GPS data to determine which stops were visited by the vehicle (and which were not), and when the vehicle was there (using information from the GPS—bearing, speed, time, location). The client 7 then sends a message to the server 3 to register the route so that the local and central models are synchronised. It contains the identity of stops passed, the duration and distance between each stop pair. The server stores this, in the server-stored model 4, for use in the future.

The server 3 does not only record each individual vehicle's prediction models, but compiles a model of the entire road network that has been driven and recorded by any vehicle.

An additional feature is that if the stops are placed more than say 10 mins apart, to provide good granularity for the predictions, the client 7 will suggest stop locations (as prediction points) that are not stoppable, in the sense that humans could meet there, but it allows the prediction engine to provide finer operation.

### Route Selection

When a driver starts to drive a journey, and turns on the OBU 6, software on the OBU 6 presents the driver with a list of routes they have previously registered, that pass or leave from the vehicle's current location. The driver, or client 7 software, selects which journey is about to be driven, and indicates this to the server. The server 3 retrieves data from the model 4 for the route already registered, which contains:
A list of stops visited
For each stop, the distance between them, and the time that is expected to elapse before the vehicle will arrive at the next stop.
The variability (standard deviation) of this time prediction.

The server 3 sends this ‘FromTo prediction’ to the client 7 and starts its own prediction ‘timer’ for this vehicle's journey. From now on the server 3 will expect to hear from this client 7 at these predicted times (within a quote margin of error), if the journey is being driven as predicted. Similarly, the client 7 receives the prediction, and based on the data provided (stops and timing) it starts its own timers to monitor progress of the vehicle against the prediction. According to the nature of the vehicle (coach, private car), for which this client is registered, the client and server may invoke a ‘DillyDaily’ until the vehicle has actually left the first stop. A ‘DillyDaily’ message from the client 7 causes both the server and the client timers to stall predictions, until the vehicle actually pulls away from the first stop. In this way, the driver can select their route, but not start driving—in order that they will appear available to share with passengers at their current location. The ‘DillyDaily’ feature can also be invoked, optionally, when the vehicle appears to be waiting at a stop along the route. This is useful in cases where a vehicle might pull into a transit stop, to wait for a train of passengers. Again the server and client would stall their timers in order to allow matches to be made at this stop.

### Driving

Normally, as the driver progresses along the journey as predicted, they reach each stop within the predicted time. As a precaution, at each stop the client 7 sends a message to the server confirming the time it arrived there, as compared to the prediction. The software on the client 7 also monitors the distance to the next stop, the time that has elapsed, and uses this to predict if it will likely arrive at the next stop within the predicted time, taking into account the variability noted by the server 3. If the client 7 decides that it is running late, calculating that it will arrive at the stop later than the predicted time, taking the quoted variability into account, the client 7 sends a ‘time out’ message. Unlike the normal update messages sent at every stop, this message provides revised predictions to the server 3. The server 3 uses these update and time-out messages to adjust its prediction for this vehicle, according to the information provided by the client 7.

The server also uses these messages to adjust the overall model 4, such that future predictions, for each link between stops, at each of hours of the week (incl. bank holidays), will be more likely to be accurate.

### Matching

Having an up to date prediction of when each vehicle will arrive at each stop, the server can select vehicles that would likely meet a passenger's request for a ride—without having to interact with all of the vehicles that might be driving at any given time. The predictions running within the server 3 are sufficient to determine the vehicle's status. The predictions running in the server 3 for each active vehicle can also support many requests (such as a moving map showing every vehicle's location) for vehicle status, without using valuable wireless communications, or regardless of whether the vehicle is in or out of coverage.

Having a model 4 of the driver's likely behaviour, and the time it takes to get from one stop to another, the server can support enquiries about the future likelihood of finding a vehicle going from one location to another, at a certain time.

### Additional Server Functionality

In the description above, the prediction server 3 uses knowledge from the vehicle's previous journeys to predict when progress will be slower or faster. In one embodiment, the prediction server 3 uses updates from other vehicles also travelling on the same route or specific route to modify the prediction of the vehicle's progress. For example, if three vehicles all report delays of 5-10 min on a particular section of road network, the prediction server 3 can anticipate delays to other similar vehicles also travelling on that route segment. The server 3 can communicate these anticipated adjustments to the clients 7 affected, such that the client's models are more accurate, when compared with the actual vehicle's progress, thus avoiding unnecessary update communications from the client 7 to the server 3.

The prediction server 3 may use third party traffic congestion information to adjust vehicle predictions. Information from induction loops can provide congestion and travel information that the prediction server 3 can use to anticipate delays.

In one embodiment the client communicates updates to the server 3 in the form of time delays. For instance, the client 7 informs the server 3 that the vehicle is 5 min behind predictions, such that the embarking time from the current road or stop can be reset. The predictions would continue as normal. The client 7 and server 3 might also adjust future predictions, based on the delays so far. That is to say, if the vehicle has lost 5 min in the first 20 min of a journey, it is likely that the vehicle will continue to travel at 25% below the normal prediction for the remainder of this journey. Recognising that not all roads are congested equally, the client 7 and server 3 may not adjust the prediction for the entire remainder of the journey equally. The prediction may be modified according to previous experience of particular route sections. For instance, if the vehicle is 5 min delayed in the first 20 min, they will be delayed by 25% for the next 10 min, but the remainder of the journey will likely be unaffected. Again, well established stochastic methods (perhaps using the state space model) can be used to model the susceptibility of the vehicle' journey to delays.

### Nature of the Geographical Model

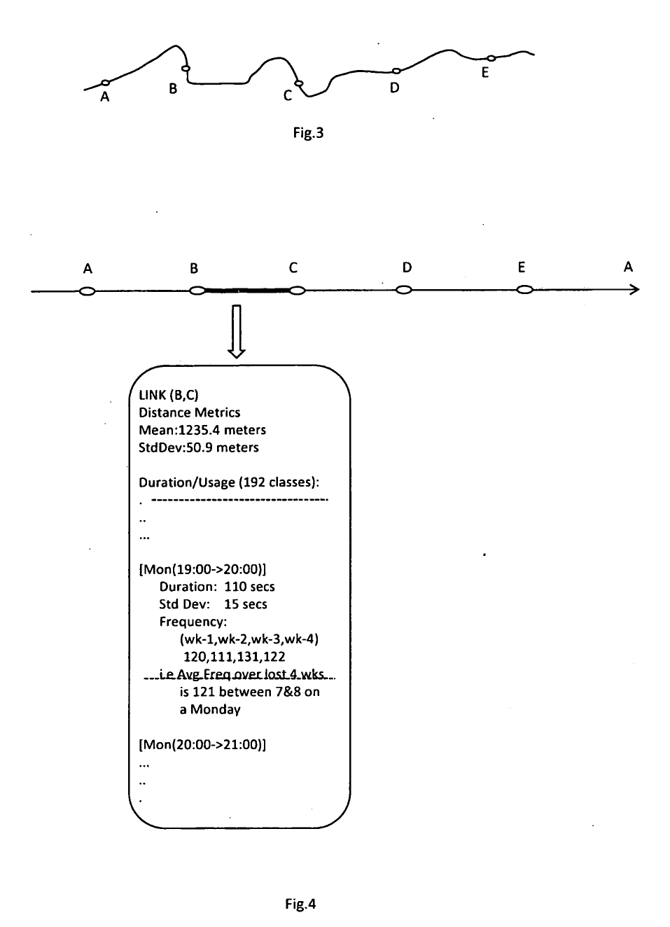

FIGS. 2 and 3 illustrate the geographic layout of a route that passes five stops (A to E). On any give journey on this route, as the driver passes the stops (A to E) the device measures the distance and duration between stops and uses the location to generate the vehicle prediction model and feeds this information to the server 3. This feedback information is aggregated with feedback from previous trips, for a given stop-to-stop link (say B to C), in one of 192 time slotted sample classes for that link, according to the time of day. That is to say, for each link a typical week is broken into 8 days-7 days+a holiday day and then further broken down into the hours of the day 192 time slots which contains feedback information. 192 is a simple linear “hour of week” sample classification system however it may be more appropriate to increase the number of sample classes representing peak times (every 15 mins between 7 am & 9 am) and reduce the number of classes at off peak times (every 2 hours 1 am->5 am). FIG. 4 illustrates this data structure for a given link (B to C).

For each of the 192 time slot sample classes the following statistics are maintained on a running basis:
Mean Duration; average time it takes to move from B to C
Sample Standard Deviation; the variability of the duration
Rolling link usage frequency; how often this link is used, therefore the probability that it will be driven. This is calculated over a configurable number of weeks—currently 4, before decaying toward zero frequency if it is not driven.
Relative link performance; a transient value that rates live feedback of the links performance (−1->+1) can be used to track “live” traffic conditions.

For each of the links in the model, across all 192 time slot sample classes the following metrics are maintained on a running basis:
Mean distance; the distance from B to C
Distance Sample standard Deviation; the variability of distance, which can be used to indicate if multiple differing routes are being used between nodes (detours)

As all calculations are “running” and/or “rolling” the data storage requirements remain fixed per topological link.

Additionally the model 4 collects and manages information about routes that each driver selects to drive. Each time a route is selected a time classified tally is updated (in one of the 192 values described above). This, based on the date and time at which a route is used by a driver allows:
(i) the system to quote the probability of a driver driving a particular route at a given time and
(ii) the system to quote the probability that a route from one stop (B) to another stop (E) being available at any given time of day.

By maintaining this data in a central server model the system 1 is able to represent to human users the service in as an intuitive ‘route map’.

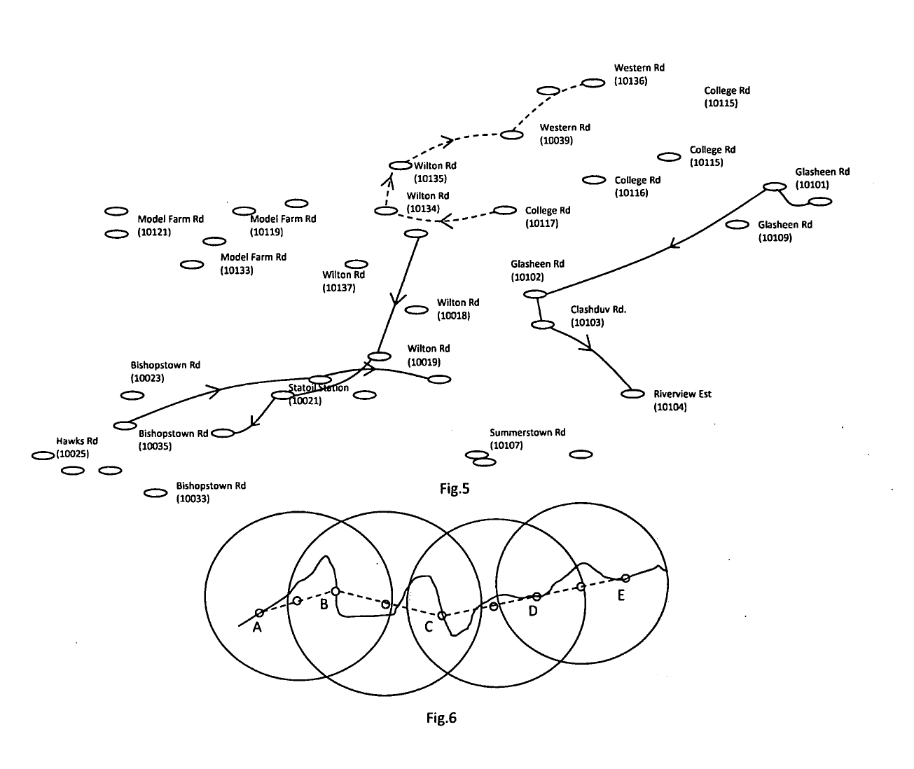

FIG. 5 is a representation of a model 4, showing stops in a given city, for a given time of day joined by lines where the link statistics are present. At this time of day the model suggests that some stops are well serviced by vehicles (solid lines). Others are not well joined (dashed lines). Further stops are not accessible at this time of day.

### Rolling Statistics

Statistics for each link, such as the mean duration and standard deviation are calculated on a rolling basis. That is to say the sample data is not accumulated over time in order to determine these values. Well known methods are used to ensure that each new sample is used to update a rolling figure. In this way the system uses a fixed amount of memory for each link in the system and is therefore more scalable.

### Stop Management

The actual route, i.e. the exact GPS location of each vehicle along each of their routes is not recorded or transmitted, since this would significantly increase the complexity and cost of the overall system. From time to time a stop will be created after routes have already been recorded by drivers that pass the stop. A mechanism is needed to ensure that these stops can be inserted or ‘injected’ into the existing routes, although the location of the vehicle along the route is not known.

When a driver selects or starts to drive a route they have already recorded in the past, the client 7 signals which route is to be driven to the server 3. The server 3 searches for new stops that should be checked by the client, to see if the driver does pass each new stop.

Every new stop cannot be passed to every device, so the server 3 uses an outlined description of their route to select the appropriate new stops, as follows
For each link (B to C) a straight-line link is drawn.
The mid point along each of these links is taken.
A circle of radius=to length B to C is scribed.
The union of all of these circles, one for each link, is used to find new stops in the vicinity of the old route.

FIG. 6 illustrates the shape created to find new stops near an existing route. Other similar methods can be used.

Once the server has identified news stops in the vicinity of the driver's route, it passes them to the client application on the device. Based on the actual position of the vehicle, which is available to the client application on the device during the journey the client can determine which of these new stops is visited by the vehicle and which is not.

For those new stops that have been visited, a message is returned to the server as to where and when the stops should be inserted into the vehicle's route.

An important strength of this mechanism is that the driver's route can evolve with their driving pattern. If they continue to change their route, this insertion process will keep adding new stops in the vicinity of the stops already recorded. Over time the server's understanding of the stops visited by the driver will reflect reality on the ground.

The mechanism also allows stops that have not been visited in a number (say three) of consecutive journeys to be dropped by the server. The client 7 notices which stops that were in the prediction were not visited at all, and transmits a message to the server 3. If, in a number of consecutive journeys, the same message is received that stop will not be included in future predictions. Old stops that were once on the driver's route will however be offered to the client as possible ‘injection’ stops, to cater for the likely event that the driver has returned to their old route habit.

### Safety and Exception Detection

The system 1 includes a number of features to detect when the driver is not following the expected prediction. For instance if the server 3 does not receive messages that a device has passed a number of consecutive stops within the time expected, it will judge that the driver has detoured. In which case, given that it can be carrying a passenger, automated alerts are generated and escalated for human intervention.

The invention is not limited to the embodiments described but may be varied in construction and detail. For example some of the functionality of the prediction client or the prediction servers could be implemented in dedicated hardware rather than software.

1. A transport management system comprising:
a plurality of on-board units each for installation in a vehicle free to travel on different routes, and comprising a wireless transceiver;
a server;
wherein each on-board unit comprises a prediction client adapted to:
monitor vehicle actual position,
use monitored vehicle actual positions to generate a vehicle prediction model of routes frequently travelled by its associated vehicle,
transmit data concerning the vehicle prediction model to the server, and
transmit vehicle progress data updates to the server as the associated vehicle travels on a route
wherein the server is adapted to:
receive said data concerning the vehicle prediction model from each prediction client and use it to generate and maintain a geographical prediction model, and
use the geographical prediction model to generate predictions of each vehicle position, so that only infrequent vehicle progress updates are required from the prediction clients.

2. A transport management system as claimed in any preceding claim, wherein the on-board unit comprises a satellite tracking device, and the prediction client receives vehicle actual location data from said satellite tracking device.

3. A transport management system as claimed in either of claim 1 or 2, wherein the server is adapted to update the geographical model according to vehicle progress updates received from the clients, so that the geographical model is synchronised with the vehicle prediction models.

4. A transport management system as claimed in any of claims 1 to 3, wherein each prediction client is adapted to compare actual vehicle location with a predicted location, and to transmit vehicle progress updates to the server only if actual vehicle location differs from predicted location by more than a tolerance level.

5. A transport management system as claimed in claim 4, wherein the tolerance level is variable.

6. A transport management system as claimed in claim 5, wherein the tolerance level varies according to time and date.

7. A transport management system as claimed in any of claims 4 to 6, wherein each prediction client determines deviation according to a clustering algorithm.

8. A transport management system as claimed in any preceding claim, wherein the data transmitted by the client concerning the vehicle prediction model is an initial model.

9. A transport management system as claimed in any preceding claim, wherein the server is adapted to apply additional information when generating predictions of a vehicle's position.

10. A transport management system as claimed in claim 9, wherein said additional information is derived from a common model of common traffic information including unusual delays on roads.

11. A transport management system as claimed in any preceding claim, wherein the prediction client is adapted to transmit an initial progress update indicating a route being commenced by an associated vehicle.

12. A transport management system as claimed in claim 11, wherein the prediction client is adapted to employ a stochastic methods to automatically determine a route being commenced without need for a user input.

13. A transport management system as claimed in any preceding claim, wherein each prediction client generates a server update when an associated vehicle passes predetermined stop locations along a predicted route.

14. A transport management system as claimed in any preceding claim, wherein the prediction client is adapted to build the vehicle prediction model on a framework of route stop data.

15. A transport management system as claimed in claim 14, wherein the server is adapted to perform automatic discovery of stops by recording stop data from progress updates from a first prediction client vehicle and applying said stop data to the a route for a second prediction client.

16. A transport management system as claimed in claim 15, wherein the server is adapted to apply regions around route stops and to identify a potential additional stop for the second vehicle if its route passes through said region.

17. A transport management system as claimed in any of claims 14 to 16, wherein each stop is given an attribute of being unidirectional or bi-directional.

18. A transport management system as claimed in any of claims 15 to 17, wherein the server is adapted to query the second prediction client before applying additional route data.

19. A transport management system as claimed in any of claims 14 to 18, wherein the vehicle prediction model comprises statistics for each of a plurality of time slots for each line between two stops.

20. A transport management system as claimed in claim 19, wherein for each time slot the following statistics are maintained on a running basis:
average time duration taken to move between the stops,
variability of the duration,
rolling link usage frequency indicating the probability that the link will be driven, and
relative link performance rating live feedback of the prediction performance for the link.

21. A computer readable medium comprising software code for performing operations of a system of any preceding claim when executing on a digital processor.
